(19) United States
(12) Patent Application Publication
(10) Pub. No.: US 2013/0271821 A1
(43) Pub. Date: Oct. 17, 2013

(54) BASE FOR ELECTROPHORESIS DISPLAY AND METHOD OF MANUFACTURING THE SAME, AND ELECTROPHORESIS DISPLAY AND METHOD OF MANUFACTURING THE SAME

(71) Applicant: SEIKO EPSON CORPORATION, Tokyo (JP)

(72) Inventors: Hiroki NAKAHARA, Shiojiri-shi (JP); Daisuke ABE, Chino-shi (JP)

(73) Assignee: SEIKO EPSON CORPORATION, Tokyo (JP)

(21) Appl. No.: 13/804,646

(22) Filed: Mar. 14, 2013

(30) Foreign Application Priority Data
Apr. 17, 2012 (JP) 2012-093916

(51) Int. Cl. G02F 1/167

(52) U.S. Cl. CPC G02F 1/167
USPC 359/296; 29/428

(57) ABSTRACT

A base for an electrophoresis display includes: a base; partition walls that are provided on one surface of the base, the opposite side to the one surface being opened; an electrophoresis material liquid that includes a dispersion medium filling at least partial cells among a plurality of cells on the base partitioned by partition walls and electrophoresis particles; and a membrane filter that is provided to close openings of the partition walls and has pores through which the dispersion medium is able to pass and the electrophoresis particles are unable to pass.

### BACKGROUND

1. Technical Field

The present invention relates to a base for electrophoresis display and a method of manufacturing the same, and an electrophoresis display and a method of manufacturing the same.

2. Related Art

The electrophoresis display has a configuration in which an electrophoresis material liquid is pinched between a pair of substrates, each having electrodes provided thereon. By generating an electric field between the electrodes of the pair of substrates, the charged particles in the electrophoresis material liquid moved between the pair of substrates and thereby a display is performed using colors of the charged particles. A method of filling a space between the pair of substrates with the electrophoresis material liquid is disclosed in JPA-2007-33680 and JP-A-2003-149689.

JP-A-2007-33680 discloses a method of manufacturing the electrophoresis display including: applying an electrophoresis ink precursor A containing electrophoresis particles to one side substrate; filling other side substrate with an electrophoresis ink precursor B; and producing an electrophoresis ink by combining the electrophoresis ink precursor A with the electrophoresis ink precursor B.

JP-A-2003-149689 discloses a method of manufacturing an electrophoresis display including: coning a coning target substrate with charged electrophoresis particles; disposing a coning target substrate to oppose a drive substrate; coning the drive substrate with the charged electrophoresis particles by moving electrophoresis particles by means of an electrophoresis effect; removing the covering target substrate disposed opposing the drive substrate; filling the drive substrate with an electrophoresis dispersion liquid; and sealing a space between a pair of substrates including the drive substrate with the electrophoresis dispersion liquid.

Any manufacturing method JP-A-2007-33680 and JP-A-2003-149689 includes: forming partition walls on one side substrate; filling regions partitioned by the particle walls with an electrophoresis dispersion liquid; and then bonding the other side substrate thereto. In that case, there is a problem in that the electrophoresis dispersion liquid overflows from cells partitioned by partition walls. There is a problem in that if the upper end of the partition walls is wet by the electrophoresis dispersion liquid, a bonding strength is insufficient when the one side substrate is bonded to the other side substrate and thus reliability is degraded.

In addition, in a case of the electrophoresis display performing a color display, it is a general configuration where each cell combined with each pixel is individually filled with each of three colors of charged particles such as red (R), green (G) and blue (B), or cyan (C), magenta (M) and yellow (Y). Therefore, the three colors of charged particles should not be mixed in a single cell. However, in a manufacturing method of the related art, since the three colors of charged particles are mixed when the electrophoresis dispersion liquid overflows from the partition walls, colors cannot be separated for each cell. Therefore, there is a problem in that the quality of the color display is degraded.

### SUMMARY

An advantage of some aspects of the invention is to provide a base for an electrophoresis display and a method of manufacturing the same and an electrophoresis display and a method of manufacturing the same.

According to an aspect of the invention, there is provided a base for an electrophoresis display including: a first base; partition walls that are provided on one surface of the first base, the opposite sides to the one surface being opened; an electrophoresis material liquid that contains electrophoresis particles and a dispersion medium filling at least partial cells, among a plurality of cells on the first base partitioned by partition walls; and a filter that is provided to close openings of the partition walls and has pores through which a dispersion medium is able to pass and the electrophoresis particles are unable to pass.

According to the aspect of the invention, a base for electrophoresis display can be realized by a manufacturing method where the electrophoresis particles are contained in at least partial cells among the plurality of cells partitioned by partition walls; the openings of the partition walls are closed with the filter; and then the dispersion liquid is caused to fill the cells through the pores of the filter. In the manufacturing process, the electrophoresis material liquid may not overflow from the partition walls, whereby inhibiting occurrence of defects.

In the base for electrophoresis display according to the aspect of the invention, a configuration may be adopted, in which the electrophoresis particles having different colors from each other are respectively contained to at least partial cells among a plurality of cells.

According to this configuration, the base for electrophoresis display may be provided in which the electrophoresis particles having different colors from each other are not mixed in the cells and thereby a high quality color display is enabled.

In the base for electrophoresis display according to the aspect of the invention, an electrode for moving the electrophoresis particles is provided on one surface of the first base.

According to this configuration, without forming new electrodes, the first substrate may be used as one side substrate of the electrophoresis display as it is.

In a base for electrophoresis display according to the aspect of the invention, an adhesive is provided on an opposite side surface to a side facing the electrophoresis material liquid of the filter.

According to this configuration, the other side substrate of the electrophoresis display may be easily bonded to the opposite side to the side facing the electrophoresis material liquid of the filter.

In the base for electrophoresis display according to the aspect of the invention, a protection film peelable from the filter is provided on an opposite side surface to a side facing the electrophoresis material liquid of the filter.

According to this configuration, the opposite side surface to the side facing the electrophoresis material liquid of the filter may be protected by the protection film when treated as the base for electrophoresis display. Therefore, the electrophoresis material liquid may be suppressed from leaking from the pores of the filter, for example.

According to another aspect of the invention, there is provided an electrophoresis display, wherein a second base is provided on the filter side in the base for electrophoresis display according to the invention, and a display is performed by moving the electrophoresis particles using an electric field between an electrode on the first base and an electrode on the second base.

According to this configuration, a high quality display may be realized and the electrophoresis display having a high reliability may be provided.

According to still another aspect of the invention, there is provided a method of manufacturing a base for electrophoresis display, including: providing one surface of a first base with partition walls where an opposite side to the one surface is opened; containing electrophoresis particles between a dispersion medium and the electrophoresis particles which configures an electrophoresis material liquid, in at least partial cells among a plurality of cells on the first base partitioned by partition walls; disposing a filter having pores through which a dispersion medium is able to pass and the electrophoresis particles are unable to pass so as to close openings of the plurality of cells, of which the cells of at least partial cells contain the electrophoresis particles therein; and filling the dispersion medium in the plurality of cells through the pores disposed at one surface of the filter.

In the method of manufacturing a base for electrophoresis display according to the aspect of the invention, the electrophoresis particles may be contained in at least the partial cells among the plurality of cells partitioned by partition walls, the openings of the partition walls are closed with the filter, and then the dispersion liquid fills in the cells through the pores of the filter. As a result, there is no possibility for the electrophoresis material liquid to overflow from the partition walls. Accordingly, defects due to the overflow may be suppressed for occurring.

In the method of manufacturing the base for electrophoresis display according to the aspect of the invention, it is preferable to further provide dispersing electrophoresis particles in the dispersion medium after that the plurality of cells are filled with the dispersion medium.

According to this configuration, the aggregation of the electrophoresis particles may be reduced and the dispersion of the electrophoresis particles may be promoted.

In the base for electrophoresis display according to the aspect of the invention, in the step of containing the electrophoresis particles in at least partial cells among the plurality of cells, a configuration in which the electrophoresis particles having different colors from each other are selectively contained with respect to each of the plurality of cells.

According to this configuration, the electrophoresis particles having different colors from each other are not mixed. Therefore, a high quality display may be realized and the electrophoresis display having a high reliability may be provided.

In the method of manufacturing a base for electrophoresis display according to the aspect of the invention, when containing the electrophoresis particles at least partial cells among the plurality of cells, it is preferable to contain a liquid material having a viscosity which is equal to or more than 10 cSt (centistockes) including the electrophoresis particles or a powder material including the electrophoresis particles.

According to this configuration, the electrophoresis particles having different colors from each other may be selectively contained in the predetermined cells using an ink jet method, a masking method or the like.

According to still another aspect of the invention, there is provided a method of manufacturing an electrophoresis display, including: providing a second base for the opposite side surface to a side facing the electrophoresis material liquid of the filter, using the base for electrophoresis display manufactured by the method of manufacturing the electrophoresis material liquid according to the invention.

According to this configuration, a high quality display may be realized and the electrophoresis display having a high reliability may be provided.

### BRIEF DESCRIPTION OF THE DRAWINGS

The invention will be described with reference to the accompanying drawings, wherein like numbers reference like elements.

FIG. 1 is a plan view illustrating an electrophoresis display according to one embodiment of the invention.

FIG. 2 is a cross-sectional view taken along the line II-II of FIG. 1.

FIG. 3 is a cross-sectional view illustrating the electrophoresis display of the present embodiment.

FIGS. 4A, 4B and 4C are cross-sectional views illustrating a method of manufacturing the electrophoresis display of the embodiment in a step-by-step process order.

FIGS. 5A, 5B, 5C and 5D are the subsequent cross-sectional views illustrating the process order of FIGS. 4A, 4B and 4C.

FIG. 6 is a cross-sectional view illustrating another example of a base for electrophoresis display.

FIGS. 7A, 7B and 7C are perspective views illustrating a specific example of an electronic device to which the electrophoresis display of the invention is applied, FIG. 7A is a perspective view illustrating an electronic book, FIG. 7B is a perspective view illustrating a watch, and FIG. 7C is a perspective view illustrating an electronic paper.

### DESCRIPTION OF EXEMPLARY EMBODIMENTS

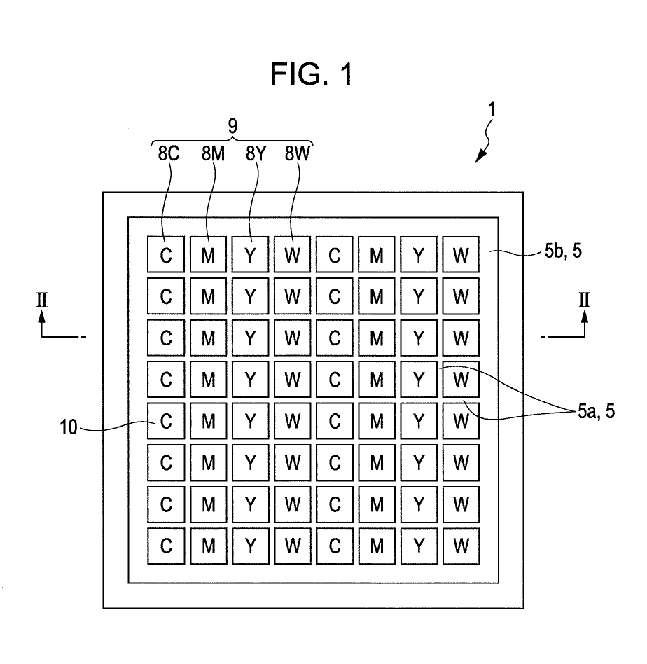

Hereinafter, one embodiment of the invention will be described with reference to FIGS. 1 to 5D.

In the embodiment of the invention, an example of a full color electrophoresis display of an active matrix type and a method of manufacturing the same will be described.

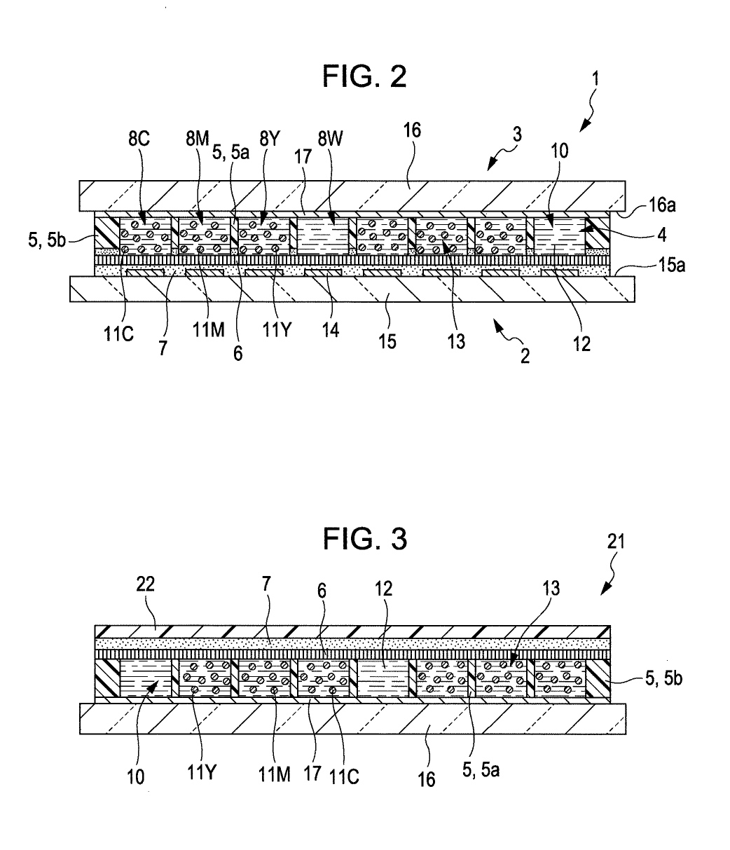

FIG. 1 is a plan view illustrating the electrophoresis display of the embodiment. FIG. 2 is a cross-sectional view along the line II-II in FIG. 1.

In addition, in order to easily illustrate each configuration element in each of the following drawings, different scales in size are illustrated depending on the configuration elements.

As illustrated in FIG. 2, the electrophoresis display 1 of the present embodiment includes a thin film transistor (hereinafter, abbreviated to TFT) array substrate 2 (second substrate), an opposing substrate 3 (first substrate), an electrophoresis layer 4, partition walls 5, a membrane filter 6 (filter) and an adhesive layer 7. The TFT array substrate 2 and the opposing substrate 3 are disposed opposing each other and bonded with a predetermined gap by partition walls 5 provided between the TFT array substrate 2 and the opposing substrate 3. That is, the TFT array substrate 2 and the opposing substrate 3 are held with a predetermined gap by partition walls 5.

As illustrated in FIG. 1, the partition walls 5 are provided in a lattice shape to extend in a first direction and a second direction (transverse direction and longitudinal direction in FIG. 1), which are orthogonal to each other. Among the partition walls 5, outermost portions 5b are formed to be wider than other portions 5a. The partition walls 5 are formed on the opposing substrate 3 side. The partition walls 5 of the TFT array substrate 2 side are opened. Openings of the partition walls 5 are closed by a membrane filter 6 to be described later. As the material of the partition walls 5, for example, the same material as a sealing material of a liquid crystal panel can be used, and for example, UV-curable acrylic resin can be used. Alternatively, a thermosetting epoxy resin may be used.

In the present embodiment, sub-pixels 8C performing a display of cyan (C), sub-pixels 8M performing a display of magenta (M), sub-pixels 8Y performing a display of yellow (Y), and sub-pixels 8W performing a display of white (W) will be placed adjacent to each other, and these four sub-pixels 8C, 8M, 8Y and 8W configure one pixel 9. Hereinafter, a space between the TFT array substrate 2 and the opposing substrate 3, that is, a rectangular region surrounded by partition walls 5a extending in a first direction and the partition walls 5a extending in a second direction is referred to as a cell 10.

Each one of sub-pixels 8C, 8M, 8Y and 8W is configured by one cell 10. Electrophoresis particles 11C, 11M and 11Y are contained in the cell 10 corresponding to the sub-pixels 8C, 8M, 8Y and 8W of different colors from each other. That is, the electrophoresis particles 11C of the cyan color are contained in the cell 10 corresponding to the sub-pixels 8C of the cyan. The electrophoresis particles 11M of the magenta color are contained in the cell 10 corresponding to the sub-pixels 8M of the magenta. The electrophoresis particles 11Y of the yellow color are contained in the cell 10 corresponding to the sub-pixels 8Y of the yellow. The electrophoresis particles are not contained in the cell 10 corresponding to the sub-pixels 8W of the white.

The inside of a plurality of cells 10 is filled with the electrophoresis material liquid 13, including a dispersion medium 12 and electrophoresis particles 11C, 11M and 11Y. An electrophoresis layer 4 is configured by the electrophoresis material liquid 13 sealing between the TFT array substrate 2 and the opposing substrate 3. In the description below, surfaces of the TFT array substrate 2 and the opposing substrate 3 which are in contact with the electrophoresis layer 4 are respectively referred to as inner surfaces.

A base 15 configuring the TFT array substrate 2 has data lines, scan lines, TFTs and the like on an inner surface 15a, but not illustrated. The configuration of the TFT array substrate 2 is well known and thus will not be described. A plurality of data lines and a plurality of scan lines are disposed which are orthogonal to each other so that each region surrounded by each data line adjacent to each other and each scan line adjacent to each other becomes sub-pixels 8C, 8M, 8Y and 8W. The TFT is disposed for each of the sub-pixels 8C, 8M, 8Y, 8W, and sub-pixel electrodes 14 are connected to the individual TFT. Therefore, as illustrated in FIG. 2, a plurality of sub-pixel electrodes 14 are formed on the inner surface 15a of the TFT array substrate 2.

The base 15 is a glass substrate, for example. However, the material of the base 15 is not limited to the glass substrate, but other material such as a plastic substrate, for example, may be used. Further, the base 15 is positioned at the opposite side to side a visually recognized by a viewer. Accordingly, the base 15 may not be necessarily a transparent material. The sub-pixel electrodes 14 are configured by a transparent conductive film such as for example, indium tin oxide (hereinafter, abbreviated as ITO). In addition, the material of the sub-pixel electrodes 14 is not limited to the ITO, but may also be other transparent conductive film. In addition, based on the same reason as the base 15, the material of the sub-pixel electrodes 14 may not be necessarily the transparent conductive material.

An inner surface 16a of the base 16 configuring the opposing substrate 3 has a common electrode 17, as illustrated in FIG. 2. The common electrode 17 is a common electrode with respect to all of the sub-pixels 8C, 8M, 8Y and 8W and is formed on the whole region of at least the display region. The base 16 is configured by the glass substrate, for example. In addition, the material of the base 16 is not limited to the glass substrate, but other material such as the plastic substrate, for example may be used. The common electrode 17 is configured by the transparent conductive film such as ITO and the like, for example. In addition, the material of the common electrode 17 is not limited to the ITO, but other transparent conductive film such as IZO and the like, for example may be used. Since the base 16 and the common electrode 17 are positioned at the side visually recognized by the viewer, it is necessary to use the transparent material.

The material of the sub-pixel electrodes 14 and the common electrode 17 is selected so that the difference of Fermi-level between the sub-pixel electrodes 14 and the common electrode 17 is decreased. The difference of the Fermi-level produces a DC voltage, which is causes electrodes to be corroded. For example, in a case where the ITO electrode and an aluminum electrode are formed, there has been known that the corrosion occurs due to the DC voltage. For this reason, it is most desirable that material of the substrate electrode 14 and the common electrode 17 should be the same.

The electrophoresis material liquid 13 configuring the electrophoresis layer 4 is configured by the dispersion medium 12 and the electrophoresis particles 11C, 11M and 11Y which are dispersed in the dispersion medium 12 and are positively charged. The dispersion medium 12 is configured by silicone oil, petroleum based medium, or the like, for example. As described above, the electrophoresis particles 11C, 11M and 11Y are configured such that the cells are respectively colored with different colors, and for example, charged groups are formed on the surface of the acrylic particles. In the present embodiment, the electrophoresis particles 11C colored with the cyan color, the electrophoresis particles 11M colored with the magenta color, and the electrophoresis particles 11Y colored with the yellow color are used.

The electrophoresis particles 11C, 11M and 11Y are movable between the sub-pixel electrodes 14 and the common electrode 17, based on an electrical potential between the sub-pixel electrodes 14 and the common electrode 17. In addition, the electrophoresis particles 11C, 11M and 11Y can be electrically absorbed with respect to the sub-pixel electrodes 14 and the common electrode 17. Further, in addition to the electrophoresis particles 11C, 11M and 11Y, uncharged particles may be included. A charging degree or a dispersing degree of the electrophoresis material liquid 13 can be adjusted by a charging agent or dispersant which is added to the electrophoresis material liquid 13.

The membrane filter 6 is provided between the TFT array substrate 2 and the electrophoresis layer 4, via the adhesive layer 7. The membrane filter 6 is disposed to close the openings of the partition walls 5 and is bonded to the TFT array substrate by the adhesive layer 7. The membrane filter 6 is a porous membrane having a plurality of pores through which the dispersion medium 12 is able to pass and the electrophoresis particles 11C, 11M and 11Y are unable to pass. As an example of the dimension, the membrane filter is configured such that, for example, a diameter of the electrophoresis particles 11C, 11M and 11Y is several hundred nm, whereas pore size in the membrane filter 6 is approximately several tens to hundred nm, and the pores in the membrane filter 6 have a configuration where the electrophoresis particles 11C, 11M and 11Y cannot pass therethrough. As the membrane filter 6, various filters having different pore sizes and materials are commercially available and may be appropriately selected in consideration of the combination of the dispersion medium and electrophoresis particles which are used.

FIG. 3 is a cross-sectional view of the base for electrophoresis display 21 used in a method of manufacturing the electrophoresis display 1 of the present embodiment. In the base for electrophoresis display 21, configurations from the base 16 configuring the opposing substrate 3 of the electrophoresis display 1 to the adhesive layer 7 are as described above. Thus, the base for electrophoresis display 21 is provided with the common electrode 17. When treated as the base for electrophoresis display 21, a protective film 22 is provided on the opposite side surface to the side facing the electrophoresis material liquid 13 of the membrane filter 6. The protective film 22 is a resin film, for example, and designed to be easily peelable from the membrane filter 6, if necessary.

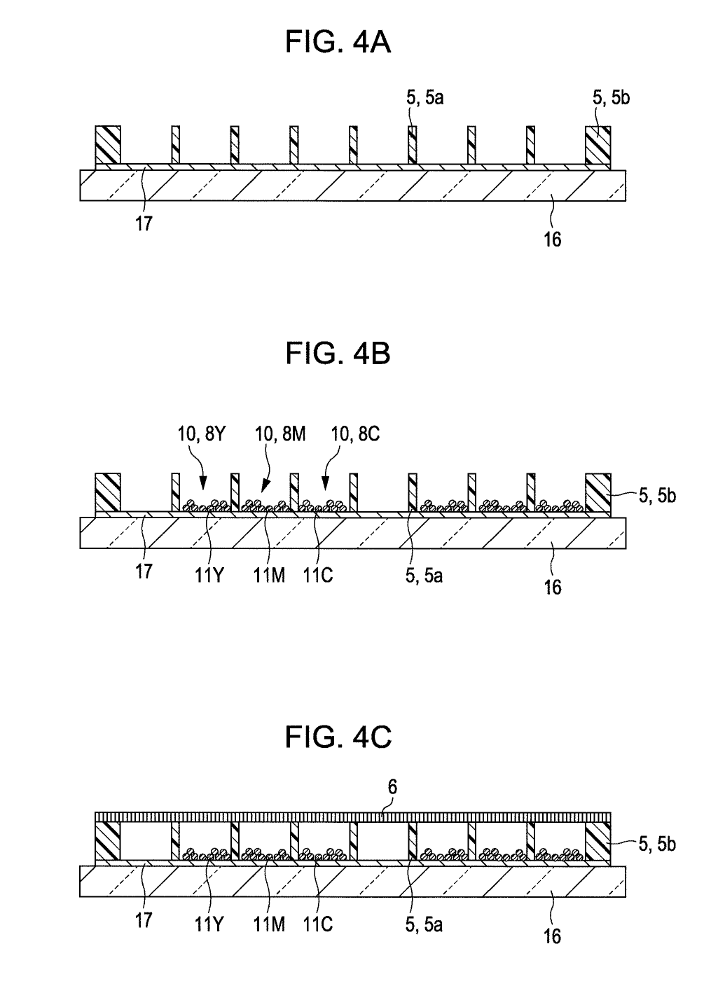

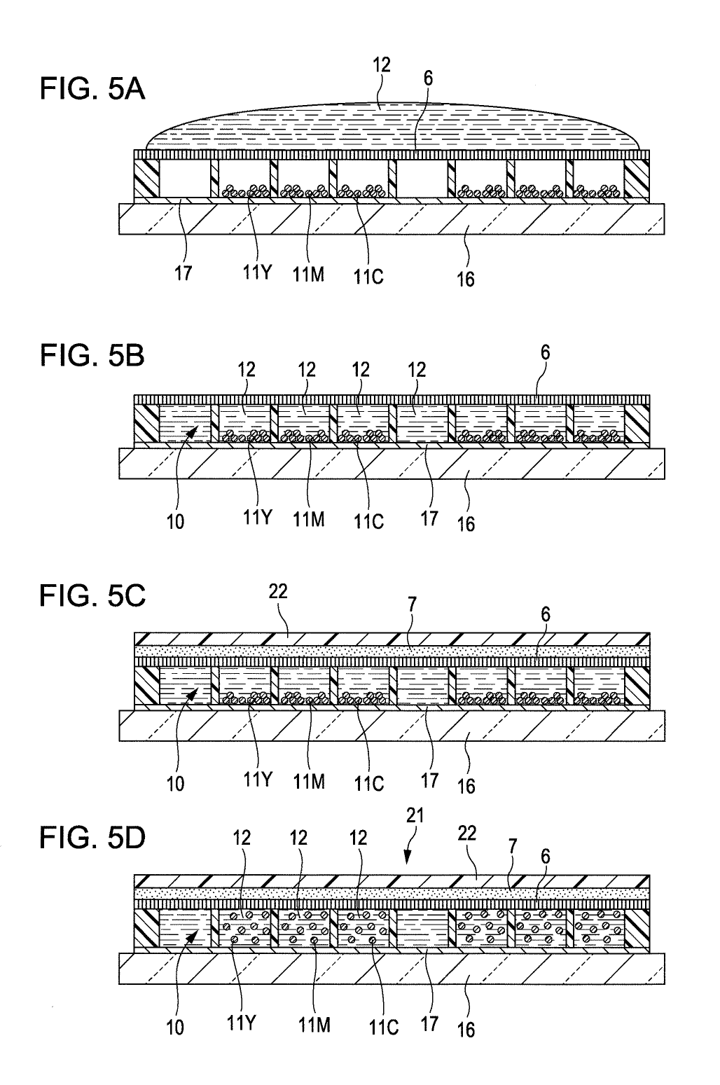

Hereinafter, the method of manufacturing the electrophoresis display 1 of the present invention will be described using the FIGS. 4A to 5D.

In addition, the process of manufacturing the electrophoresis display 1 includes a process of manufacturing the base for electrophoresis display 21.

Firstly, as illustrated in FIG. 4A, for example, the transparent conductive film such as ITO is formed on one surface of the transparent base 16, by means of a sputtering method and the like, and then the conductive film is patterned to form the common electrode 17.

Next, a photosensitive resin film such as a photosensitive acrylic resin is formed on one surface of the base, and then a photosensitive resin film is patterned to form the partition walls 5 (5a and 5b) where the opposite side to the one surface is opened.

Next, as illustrated in FIG. 4B, among the cells 10 partitioned by partition walls 5, the electrophoresis particles 11C, 11M and 11Y having different colors are selectively contained inside the cells 10 except for the cells 10 corresponding to the sub-pixels 8W of the white. That is, the electrophoresis particles 11C of the cyan color is contained in the cells 10 corresponding to the sub-pixels 8C of the cyan, the electrophoresis particles 11M of the magenta color is contained in the cells 10 corresponding to the sub-pixels 8M of the magenta, and the electrophoresis particles 11Y of the yellow color is contained in the cells 10 corresponding to the sub-pixels 8Y of the yellow.

As one of the specific methods in which the electrophoresis particles 11C, 11M and 11Y are contained inside the cell 10, a method is exemplified in which three types of liquid materials including the electrophoresis particles 11C, 11M and 11Y and having a viscosity which is equal to or more than 10 cSt are prepared and then the three types of liquid materials selectively fill each cell using an ink jet method which is a type of printing methods. Alternatively, as the other method, a masking method is exemplified in which three types of powder materials containing any of the electrophoresis particles 11C, 11M and 11Y are respectively prepared, and using a mask having openings corresponding to the cells 10 corresponding to the sub-pixels 8C, 8M and 8Y of the same color, the three kinds of powder materials are ejected through the openings of the mask so as to selectively fill each cell. Even though any method is used, in order that the upper surface of the filling liquid or powder materials does not exceed the height of the partition walls 5, it is necessary to control the amount of the liquid or powder materials.

Next, as illustrated in FIG. 4C, so as to close the openings of the plurality of the cells 10, the membrane filter 6 having a plurality of pores is fixed on the upper surface of the partition walls 5, through which the dispersion medium 12 is able to pass and the electrophoresis particles 11C, 11M and 11Y are unable to pass. As the method of fixing the membrane filter 6 on the upper surface of the partition walls 5, the adhesive may be transferred onto the upper surface of the partition walls 5 and thereafter, the membrane filter 6 may be bonded to the upper surface of the partition walls 5. Alternatively, the membrane filter 6 may be welded to the upper surface of the partition walls 5 by being heated.

Next, as illustrated in FIG. 5A, the dispersion medium 12, which is made of silicone oil, petroleum based medium, or the like, is disposed on the upper surface of the membrane filter 6 using a coating method, a spraying method, a dripping method, and the like.

Next, as illustrated in FIG. 5B, the dispersion medium 12 fills the cells 10 through a plurality of pores of the membrane filter 6. At this time, the dispersion medium 12 may penetrate through the pores by its own weight, but it is preferable to use a method of placing the base 16 where the dispersion medium 12 is disposed on the upper surface of the membrane filter 6, under a weak vacuum atmosphere. The vacuum condition is set to generate a pressure difference which exceeds a required bubble point using a combination of the membrane filter 6 and the dispersion medium 12 which are used. In the latter method, air inside the cell 10 is replaced with the dispersion medium 12, and the dispersion medium 12 is absorbed into the cell 10. According to this method, the time required for filling of the dispersion medium 12 may be reduced.

Next, as illustrated in FIG. 5C, the adhesive is applied to the upper surface of the membrane filter 6 to form the adhesive layer 7. Then, the protective film 22 is disposed on the upper surface of the membrane filter 6 via the adhesive layer 7. As a result, the plurality of pores of the membrane filter 6 are closed by the adhesive. Therefore, the dispersion medium 12 may be prevented from leaking through the pores of the membrane filter 6.

As illustrated in FIG. 5D, the electrophoresis particles 11C, 11M and 11Y, which are collected in the bottom portion of the cell 10, are dispersed in the dispersion medium 12. At this time, for example, processes such as applying an ultrasonic wave vibration to the base 16 or heating the base 16 are performed. By applying these processes, the electrophoresis particles 11C, 11M and 11Y may be more uniformly dispersed in the dispersion medium 12. These processes suppress the aggregation of the electrophoresis particles 11C, 11M and 11Y and further promote the dispersion of the electrophoresis particles 11C, 11M and 11Y. However, in a case where dispersibility of the electrophoresis particles 11C, 11M and 11Y is high, it is not necessarily to perform this process.

The above-described process allows the base for electrophoresis display 21 to be completed.

When manufacturing the electrophoresis display 1 using the base for electrophoresis display 21, the protective film 22 on the base for electrophoresis display 21 is peeled off and then the separately produced TFT array substrate 2 is attached to the base for electrophoresis display 21 through the adhesive layer 7.

The above described process allows the electrophoresis display 1 shown in FIG. 2 to be completed.

In the present embodiment, the electrophoresis particles 11C, 11M and 11Y are contained inside the cells 10 on the base 16, the openings of the partition walls 5 are closed by the membrane filter 6 and then, the dispersion medium 12 fills the cells 10 through the plurality of pores of the membrane filter 6. Accordingly, without mixing the electrophoresis particles 11C, 11M and 11Y, having different colors from each other, within one cell 10, the electrophoresis display 1 having the sub-pixels 8C, 8M, 8Y and 8W, which is excellent in the dispersibility of color may be provided. As a result, the electrophoresis display 1 capable of displaying a high quality color may be realized.

In addition, in the manufacturing method of the present embodiment, since the process of bonding the other substrate in a state that the upper surface of the partition walls 5 is wet by the electrophoresis material liquid 13 is not present, the TFT array substrate 2 and the opposing substrate 3 are reliably bonded to each other through the partition walls 5. As a result, the electrophoresis display 1 having a high reliability may be realized. In addition, since the base 16 of the base for electrophoresis display 21 is used as the opposing substrate 3 of the electrophoresis display 1 as it is, the manufacturing process may be simplified.

### Electronic Equipment

Next, cases where the electrophoresis display 1 of the present embodiment is applied to electronic equipment will be described.

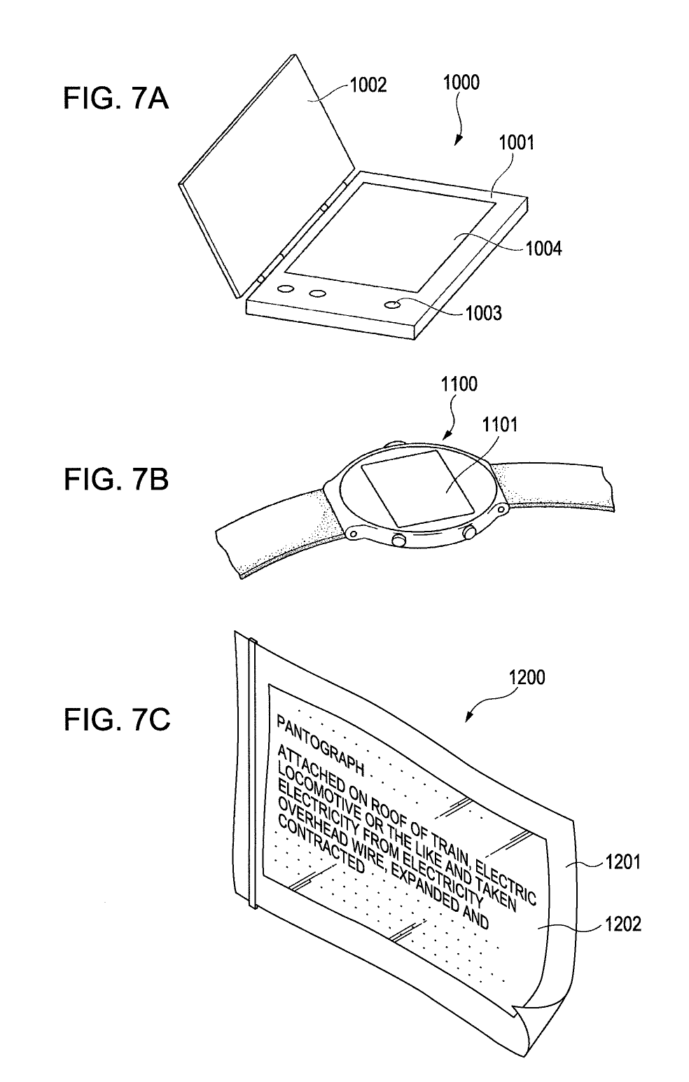

FIGS. 7A to 7C are perspective views for explaining the specific examples of the electronic equipment to which the electrophoresis display 1 of the invention is applied.

FIG. 7A is a perspective view illustrating an electronic book which is an example of the electronic equipment. The electronic book 1000 includes a frame 1001 having a book shape, a cover (openable and closable) 1002 provided rotatably with respect to the book-shaped frame 1001, an operation unit 1003, and a display unit 1004 configured by the electrophoresis display 1 of the above-described embodiment.

FIG. 7B is a perspective view illustrating a watch which is an example of the electronic equipment. The watch 1100 is provided with a display unit 1101 configured by the electrophoresis display 1 of the above-described embodiment.

FIG. 7C is a perspective view illustrating an electronic paper which is an example of the electronic equipment. The electronic paper 1200 is provided with a main body unit 1201 that is configured by a rewritable sheet having the same texture and flexibility as the paper, and a display unit 1202 that is configured by the electrophoresis display 1 of the above-identified embodiment.

For example, it is necessary for the electronic book, electronic paper, and the like to eliminate a residual image when erasing it and sequentially a residual image since there may be a use of repeatedly writing characters on a white background.

Further, a range of the electronic equipment which can adopt the electrophoresis display 1 of the invention is not limited thereto, but broadly includes a device that utilizes a visual change in color due to the movement of charged particles.

According to the electronic book 1000, the watch 1100 and the electronic paper 1200, since the electrophoresis display according to the above-identified embodiment is adopted, inexpensive electronic devices can be provided.

In addition, the electronic equipment described above does not limit the technical range of the invention. For example, it is possible to preferably use the electrophoresis display according to the invention to a display unit of the electronic equipment such as a mobile phone, potable audio equipment and the like, or to in a business sheet such as manuals, a text book, a work book, an information sheet and the like as well.

In addition, the technical range of the invention is not limited to the embodiment described above, it is possible to add various modifications within the scope without departing from the spirit of the invention.

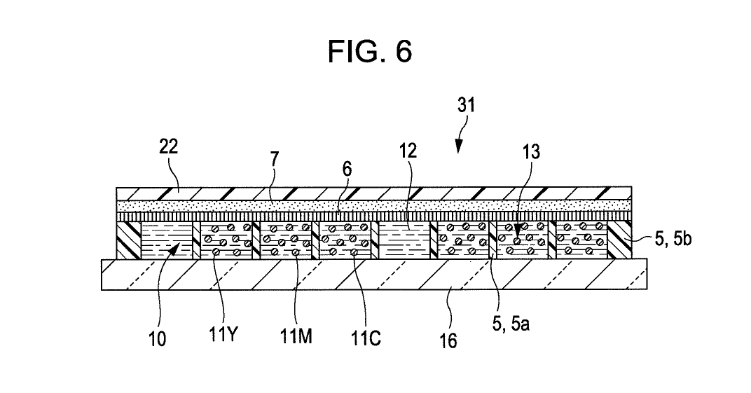

For example, the above-described embodiment illustrates an example where the common electrode is formed on one surface of the base configuring the base for electrophoresis display, and the base is used as the opposing substrate of the electrophoresis display as it is. For example, instead of the configuration as illustrated in FIG. 6, the base for electrophoresis display 31 may be used where the common electrode is not formed on the one surface of the base 16. However, when manufacturing the electrophoresis display using the base for electrophoresis display 31, it is necessary to bond the opposing substrate including the common electrode in addition to the TFT array substrate to the base for electrophoresis display 31.

Alternately, contrary to the above embodiment, wires such as data lines, scan lines and the like, or TFTs and the sub-pixel electrodes may be formed on the one surface of the base configuring the base for electrophoresis display 31, and the base may be used as the TFT array substrate of the electrophoresis display as it is. In this case, the partition walls may be formed on above the sub-pixel electrodes, and the base for electrophoresis display 31 including the TFT and the sub-pixel electrodes may be manufactured by the same manufacturing process as that in the above embodiment. In addition, when manufacturing the electrophoresis display, it is necessary to bond the opposing substrate including the common electrode.

In the above embodiment, an example where one sub-pixel is configured by one cell is described, but the one sub-pixel may be configured by a plurality of cells. In this case, the electrophoresis particles having the same color may fill the plurality of cells configuring the same sub-pixel. In the above embodiment, an example of the full color electrophoresis display including sub-pixels of C, M and Y is described, but it may be the full color electrophoresis display including sub-pixels of red (R), green (G) and blue (B).

Further, the invention is not limited to the full color electrophoresis display, but may be the electrophoresis display including one color of the electrophoresis particles only, and for example, may be applied to a black and white electrophoresis display. In this case, there is no problem in that colors of the electrophoresis particles are not mixed in the cell. However, various problems such as the decreased bonding strength due to the wet upper edge of the partition wall by the electrophoresis material liquid, and the like may be solved.

In the above embodiment, an example of an active matrix type of the electrophoresis display is described, but the invention may also be applied to a passive matrix type of the electrophoresis display in which stripe shaped electrodes are provided for each of a pair of substrates, or to a segment type of the electrophoresis display. Additionally, the number, disposition, material, formation method and the like of various configuration elements of the electrophoresis display are not limited to those in the embodiment, but may be appropriately modified.

The entire disclosure of Japanese Patent Application No. 2012-093916, filed Apr. 17, 2012 is expressly incorporated by reference herein.

What is claimed is:

1. A base for an electrophoresis display, comprising:
a first base;
partition walls that are provided on one surface of the first base, the opposite side to the one surface being opened;
an electrophoresis material liquid that contains electrophoresis particles and a dispersion medium filling at least partial cells, among a plurality of cells on the first base partitioned by partition walls; and
a filter that is provided to close openings of the partition walls and has pores through which a dispersion medium is able to pass and electrophoresis particles are unable to pass.

2. The base for an electrophoresis display according to claim 1,
wherein the electrophoresis particles having different colors from each other are respectively contained in each of cells of at least partial cells among the plurality of cells.

3. The base for an electrophoresis display according to claim 1,
wherein an electrode for moving the electrophoresis particles is provided on one surface of the first base.

4. The base for an electrophoresis display according to claim 1,
wherein an adhesive is provided on a surface of the filter on a side opposite to a side of the filter which faces the electrophoresis material liquid.

5. The base for an electrophoresis display according to claim 1,
wherein a protection film peelable from the filter is provided on an opposite side surface to a side facing the electrophoresis material liquid of the filter.

6. An electrophoresis display,
wherein a second base is provided on the filter side in the base for an electrophoresis display according to claim 1, and
a display is performed by moving the electrophoresis particles using an electric fields between the electrodes on the first base and an electrode on the second base.

7. An electrophoresis display,
wherein a second base is provided on the filter side in the base for an electrophoresis display according to claim 2, and
a display is performed by moving the electrophoresis particles using an electric field between an electrode on the first base and an electrode on the second base.

8. An electrophoresis display,
wherein a second base is provided on the filter side in the base for an electrophoresis display according to claim 3, and
a display is performed by moving the electrophoresis particles using an electric field between an electrode on the first base and an electrode on the second base.

9. An electrophoresis display,
wherein a second base is provided on the filter side in the base for an electrophoresis display according to claim 4, and
a display is performed by moving the electrophoresis particles using an electric field between an electrode on the first base and an electrode on the second base.

10. An electrophoresis display,
wherein a second base is provided on the filter side in the base for an electrophoresis display according to claim 5, and
a display is performed by moving the electrophoresis particles using an electric field between an electrode on the first base and an electrode on the second base.

11. A method of manufacturing a base for an electrophoresis display, comprising:
providing one surface of a first base with partition walls where an opposite side to the one surface is opened;
containing electrophoresis particles between a dispersion medium and the electrophoresis particles which configure an electrophoresis material liquid, in at least partial cells among of a plurality of cells on the first base partitioned by partition walls;
disposing a filter having pores through which a dispersion medium is able to pass and the electrophoresis particles are unable to pass so as to close openings of the plurality of cells, at least partial cells of which contain the electrophoresis particles; and
filling the plurality of cells with the dispersion medium through the pores by disposing the dispersion medium on the one surface of the filter.

12. The method of manufacturing a base for an electrophoresis display according to claim 11, further comprising:
dispersing the electrophoresis particles in the dispersion medium after the plurality of cells are filled with the dispersion medium.

13. The method of manufacturing a base for an electrophoresis display according to claim 11,
wherein when containing the electrophoresis particles in at least partial cells among of the plurality of cells, the electrophoresis particles having different colors from each other are selectively contained with respect to any of the plurality of cells.

14. The method of manufacturing a base for an electrophoresis display according to claim 13,
wherein when containing the electrophoresis particles in at least partial cells among the plurality of cells, a liquid material having a viscosity which is equal to or more than 10 cSt including the electrophoresis particles, or a powder material including the electrophoresis particles is contained.

15. A method of manufacturing an electrophoresis display, comprising:
providing a second base for the opposite side surface to a side facing the electrophoresis material liquid of the filter, using the base for an electrophoresis display manufactured by the method of manufacturing the base for an electrophoresis display according to claim 11.

16. A method of manufacturing an electrophoresis display, comprising:
providing a second base for the opposite side surface to a side facing the electrophoresis material liquid of the filter, using the base for an electrophoresis display manufactured by the method of manufacturing the base for an electrophoresis display according to claim 12.

17. A method of manufacturing an electrophoresis display, comprising:
providing a second base for the opposite side surface to a side facing the electrophoresis material liquid of the filter, using the base for an electrophoresis display manufactured by the method of manufacturing the base for an electrophoresis display according to claim 13.

18. A method of manufacturing an electrophoresis display comprising:
providing a second base for the opposite side surface to a side facing the electrophoresis material liquid of the filter, using the base for an electrophoresis display manufactured by the method of manufacturing the base for an electrophoresis display according to claim 14.
